(19) United States
(12) Patent Application Publication
(10) Pub. No.: US 2026/0283086 A1
(43) Pub. Date: Sep. 24, 2026

(54) IRRIGATION SYSTEM

(71) Applicant: Deere & Company, Moline, IL (US)

(72) Inventor: RITESH S. KONDEKAR, Pune (IN)

(21) Appl. No.: 19/251,972

(22) Filed: Jun. 27, 2025

(30) Foreign Application Priority Data
Mar. 19, 2025 (IN) 202521024408

(51) Int. Cl. A01G 25/09; A01G 23/00

(52) U.S. Cl. CPC A01G 25/09; A01G 23/00

(57) ABSTRACT

A work machine for irrigation of saplings in silviculture. The work machine comprises a chassis along with a propelling unit and ground-engaging elements. A hydrating module is attached to the chassis. The hydrating module comprises a hydrating fluid storage tank, a fluid delivery member, and a plurality of nozzles arranged in series and parallel to the length of the work machine. An identifying unit is provided to identify the location of a sapling on the ground. The identifying unit outputs a signal when a sapling is identified. The hydrating control unit operates the plurality of nozzles in sequence such that the sprayed water from each nozzle reaches the identified sapling.

### CROSS-REFERENCE TO RELATED APPLICATIONS

This application claims priority under 35 U.S.C. § 119 to patent application IN 202521024408, filed on 19 Mar. 2025, the disclosure of which is incorporated herein by reference.

### Field of the Disclosure

The present disclosure relates generally to silviculture and more particularly to vision based irrigation systems using a work machine.

### BACKGROUND OF THE DISCLOSURE

The silviculture process can be slow, cumbersome, and may require careful handling because the process involves planting fragile saplings into the ground. Furthermore, precision in planting depth, subsequent watering, fertilization, water retention around the sapling, and adequate spacing between saplings are some of many variables adding to the complexity to optimize the survival rates and growth of saplings once planted. Saplings can generally be sensitive to the environmental conditions, handling, and conditions of planting. Generally done by hand, therein lies a need for an automated or semi-automated process to efficiently and carefully plant a multitude of saplings into the ground to support reforestation efforts.

Mechanization of various activities of silviculture has been improving over the years and various models of sapling planting machines were developed to plant large number of saplings within a short span of time. These machines handle the saplings with care and avoid damage. Known planting machines carry huge volumes of water to hydrate the sapling while planting the sapling.

The planting machines hydrate the saplings while planting, but it is not efficient to use the same planting machine to supply water to the planted saplings at a later time. Typically, a water cart is drawn by a tractor and water is supplied to each sapling and is controlled manually.

Large number of saplings which are planted over vast regions need to be watered periodically. To fulfill such a requirement, an efficient watering solution is required.

Hence, there is a requirement for a novel mechanized and automated watering device that addresses the issues associated with the existing sapling irrigation systems.

### SUMMARY OF THE DISCLOSURE

An object of the present disclosure is to provide a work machine to irrigate saplings with accuracy and speed.

Another object of the present disclosure is to provide a mechanism to supply water to a sapling through a plurality of nozzles arranged parallel to the work machine and operating the nozzles in a sequence such that the hydrating fluid is sprayed on to the sapling.

Yet another object of the present disclosure is to optimize the operation of sapling watering.

In accordance with the present disclosure of an irrigation system using a work machine is provided. The work machine may comprise a chassis, a distal end, a proximal end, and a length between the distal end and the proximal end. A hydrating module is attached to the chassis. The hydrating module comprises a hydrating fluid storage tank and a fluid delivery module with a plurality of nozzles arranged parallel to the length of the work machine. The nozzles are fluidly connected to the hydrating fluid storage tank. A hydrating control unit operates the plurality of nozzles to dispense hydrating fluid to a sapling on the ground.

An identifying unit is provided to determine a location of an entity and generate a signal. The hydrating control unit operates the plurality of nozzles in a sequence such that the hydrating fluid is sprayed towards the entity or sapling.

The sequence may include operating each nozzle individually and operating all nozzles at and for a certain amount of time, which is further dependent on the speed of work machine.

The fluid delivery member comprises a plurality of nozzles arranged into two arrays to distribute the fluid flow around the sapling.

The work machine further comprises a steering system and steering the work machine according to a pre-recorded path. The pre-recorded path could be recorded during planting of the saplings.

Other features and aspects will become apparent by consideration of the detailed description and accompanying drawings.

### BRIEF DESCRIPTION OF THE DRAWINGS

FIG. 1 illustrates a side view of a work machine with a fluid delivery member coupled at a rear end;

FIG. 2 illustrates an embodiment of fluid delivery member;

FIG. 3A illustrates a first embodiment of an operating sequence strategy for nozzles;

FIG. 3B illustrates a second embodiment of an operating sequence strategy for nozzles; and

FIGS. 4 illustrates a flow chart explaining the operation of an irrigation system.

### DETAILED DESCRIPTION

The embodiments disclosed in the above drawings and the following detailed description are not intended to be exhaustive or to limit the disclosure to these embodiments. Rather, there are several variations and modifications which may be made without departing from the scope of the present disclosure.

As used herein, the term “controller” is a computing device including a processor and a memory. The “controller” may be a single device or alternatively multiple devices.

As used herein, the term “module” refers to any hardware, software, firmware, electronic control component, processing logic, processing device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

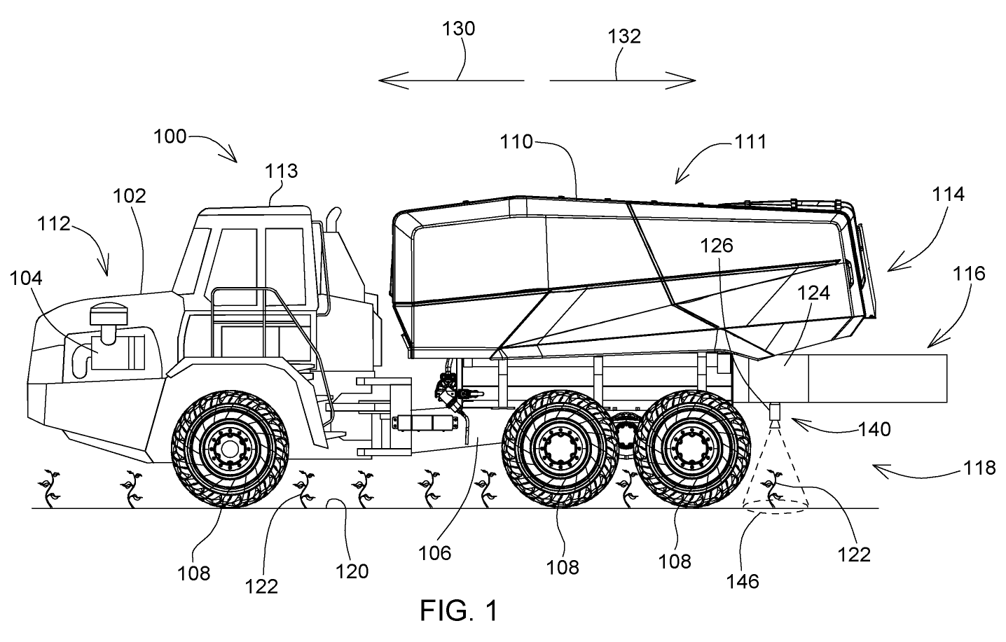

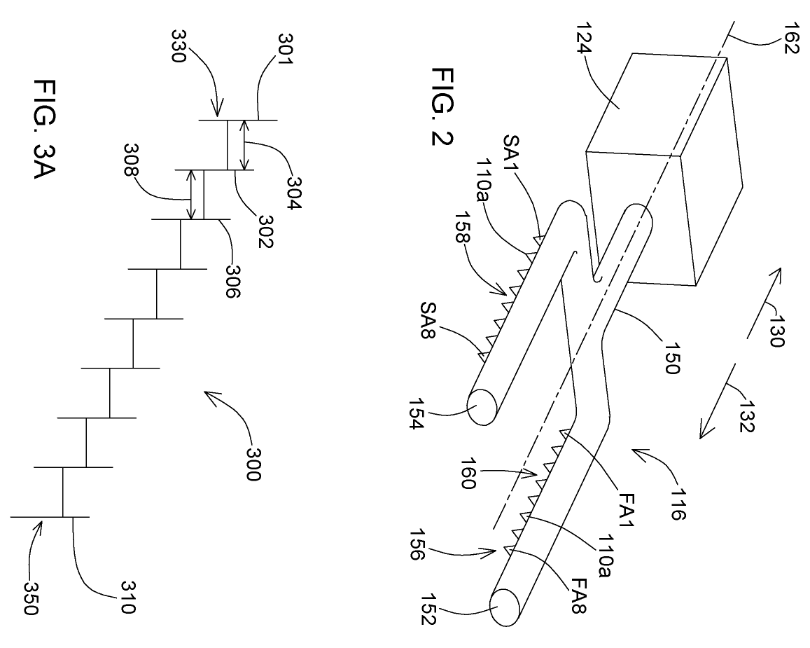

FIG. 1 illustrates a work machine 100 comprising an irrigation system. A hydrating module 111 is attached at rear end 114 of the work machine 100, according to one embodiment. It is intended that the hydrating module 111 spray water for each entity such as a sapling 122 wherein the work machine 100 continues to advance along the ground 120 in forward direction, thereby advantageously reducing fuel consumption and increasing efficiency by minimizing a stop/start of the work machine 100 when spraying water or hydrating fluid 110a (FIG. 2) to each sapling 122. An alternative embodiment of an irrigation system may comprise hydrating module 111 coupled to a work machine 100, such as a tractor, rather than a single piece of equipment. Therein, the term work machine 100 may include a hydrating module 111 attached to a work machine 100, or a work machine 100 towing a hydrating module 111. Note that the hydrating module is one of several subcomponents found within the irrigation system. Furthermore, the terms “work machine,” “irrigation vehicle” and “irrigation machine” may be used interchangeably throughout this disclosure.

The work machine 100 may comprise of one or more subcomponents and/or subsystems described herein to automate or semi-automate the irrigation process. The present disclosure includes a work machine 100 with multiple subsystems. However, used holistically or in part, these subsystems provide an improved process for irrigating multiple saplings 122 through the automated or a semi-automated process. The work machine 100 may include a chassis 106, ground-engaging elements 108 such as wheels, and a propulsion system 104. The propulsion system 104 such as a diesel engine or an electric engine provides for motive power driving the ground-engaging elements 108 and for operating the other components associated with the work machine 100 such as actuators or pumps for water or hydrating fluid. The operator cab 113, or alternatively a remote operating station (not shown) where an operator sits when operating the work machine 100, includes a user input interface with a plurality of controls (e.g. steering, switches, joysticks, pedals, buttons, levers, display screens, touch pads etc.) for controlling the work machine 100 during operation thereof.

The operator drives the work machine 100 along the row of saplings 122 for suppling water or hydrating fluid 110a to each sapling 122 in the row. For each row, the operator drive the work machine 100 such that the fluid delivery system 116 is positioned close to the saplings 122. In an embodiment, the fluid delivery system 116 is at rear end 114 of the work machine 100 and at middle point in the width direction of the work machine 100. In such case, the work machine 100 is steered such that the row of saplings 122 comes at the center of the work machine width. The steering system could be an automatic system controlled by a controller or a hydrating control unit 102 and steers the work machine 100 according to various inputs. The steering inputs may comprise any individual or a combination of inputs given by the vehicle operator, predetermined map of path and sensors which detect the terrain/ground 120 and/or saplings 122 upfront of the work machine 100 and derive a preferred path. A camera may be installed on the vehicle chassis 106 to observe the ground 120.

As depicted, the proximal end 112 or forward direction 130 of the work machine 100 is generally to the left and the rear end 114 or rear direction 132 of the work machine 100 is generally to the right. The work machine 100 may further include an external housing, which generally shields various subcomponents of the work machine 100 from dust, debris, winds, rain, and other harsh environmental conditions. The primary subcomponents and subsystems may include a hydrating module 111 attached to the chassis 106. The hydrating module 111 may further comprise a hydrating fluid storage tank 110, fluid delivery system 116. The work machine 100 may further comprise a controller or hydrating control unit 102 to control various operations of the work machine 100 and the hydrating module 111.

The controller or control unit or hydrating control unit 102 may have one or more microprocessor-based electronic control units or controllers which perform calculations and comparisons and execute instructions. The hydrating control unit 102 may also include a processor, a core, volatile and non-volatile memory, digital and analog inputs, and digital and analog outputs. The hydrating control unit 102 may connect to and communicate with various input and output devices including, but not limited to, switches, relays, solenoids, actuators, light emitting diodes (LED's), liquid crystal displays (LCD's) and other types of displays, radio frequency devices (RFD's), sensors, and other controllers. The hydrating control unit 102 may receive communication or signals, via electrically or any suitable electromagnetic communication, from one or more devices, determine an appropriate response or action, and send communication or signals to one or more devices. The hydrating control unit 102 can be a programmable logic controller, also known as a PLC or programmable controller. The hydrating control unit 102 may couple to a separate work machine electronic control system through a data bus, such as a CAN bus, or the controller can be a part of the work machine electronic control system. The hydrating control unit 102 may further include an image analysis system to process the images from the image sensors.

The hydrating control unit 102 may be in communication with one or more devices including, but not limited to, a vehicle speed sensor to receive information about the vehicle ground speed; position/proximity sensors to receive various positional inputs of various sub systems such as fluid delivery system 116; geo-location sensors to receive information about the work machine's location; obstruction detector sensors; the pump and/or pump controller to provide commands or instructions and/or receive information about direction and flow of hydrating fluid to and from the hydrating fluid storage tank 110; inputs from cameras; and the user input interface to receive commands or instructions and provide feedback. The hydrating control unit 102 may receive communication from and provide communications, controls, or instructions to any of these devices and any of the subcomponents. This list is not all-inclusive and is detailed further below. It is contemplated that various control units or processing units mentioned in this disclosure such as control unit, hydrating control unit, image analysis system or not necessarily separate units but a single control unit may handle all the processing or control talks.

In an embodiment, the work machine 100 may be used to supply a hydrating fluid 110a to an entity, which may include but not be limited to a sapling 122, plant, tree, weed, stump and a stubble. The work machine operator may select an entity type to be watered or supplied with hydrating fluid and the irrigation system will continue to work as described. This way, the work machine may be used as a multipurpose dispenser.

The work machine 100 may further comprise an identifying unit 140 to detect the sapling / entity 122 on ground 120. The identifying unit 140 may use a vision sensor or a GNSS (global navigation satellite systems) to identify location of an entity on ground. It is possible to use either of the methods or use both methods to increase accuracy by corroborating the position data of entity / sapling 122.

In a vision based identifying unit, as shown in FIG. 1, the work machine 100 is moving forward direction 130 on the ground 120, the sensor 126 looks onto the ground 120 ahead of the fluid delivery system 116 and captures the images or video of the ground 120 and saplings 122. In an embodiment, as shown in FIG. 1 the sensor 126 is placed on frame block 124 between the fluid delivery system 116 and the hydrating fluid storage tank 110 of the work machine 100. In the described embodiment, the sensor 126 comprises a camera. However, any sensor including but not limited to ultrasonic, laser, radar sensors which can recognize a sapling 122 on the ground 120 could be used. The sensor 126 may further include an image analysis system to identify the sapling 122 from the image from the sensor 126. The sensor 126 may further record the position of the sapling 122. In an embodiment, the location of the sapling 122 is relative to a calibrated reference location on chassis 106 of the work machine 100. However, the position of the sapling 122 could be of relative to the fluid delivery system 116 or absolute coordinates based on GNSS system. The identifying unit 140 may further record the speed of the work machine 100 and generate a signal including the position of the sapling 122 and the speed of the work machine 100.

In a GNSS based identifying unit 140, the location of sapling 122 is recorded during the process of transplanting or any other time before initiating the irrigation process. In an embodiment, during transplanting of saplings 122 in a field, the controller of transplanting machine, by using GNSS, may record the absolute coordinates of the location where the sapling 122 is planted on the ground 120. Additionally, the controller may also record the travelling path of the transplanting machine. The recorded path and location of each sapling is stored in a convenient location such as cloud or on physical storage media. During irrigation, the work machine 100 may retrieve the stored path and steer according to the recorded path. The identifying unit 140 may further record the speed of the work machine 100 and generate a signal including the position of the sapling 122 as per the stored records and the speed of the work machine 100.

FIG. 2 illustrates an embodiment of fluid delivery module 118 (FIG. 1). Frame block 124 is connected to the rear end 114 of the work machine 100. A boom 150 is supported on frame block 124. The boom 150 is divided into a first branch 152 and a second branch 154. The first and second branches (152, 154) are spaced apart such that they are equally spaced from the center axis 162 of the work machine 100. A plurality of nozzles 160 are placed on the boom 150. In the shown embodiment, a first array 156 of eight nozzles (FA1, FA2….FA8) are placed on first branch 152 and a second array 158 of eight nozzles (SA1, SA2….SA8) are placed on the second branch 154. The first nozzle FA1 of the first array 156 and first nozzle SA1 of the second array 158 are placed at equal distance from the reference point on the work machine 100. With this arrangement, both first nozzles from each array form a plane (not shown). Since nozzles in each array have equal distance between two consecutive nozzles, every nozzle from the first array 156 form a plane with the opposite nozzle from the second array 158. Nozzles are attached to the branch 152, 154 such that when water or other hydrating fluid 110a is sprayed, the water or other hydrating fluid 110a falls close to the sapling 122. This can be done by aligning the axis of the nozzle to connect with a line on the ground 120 which falls at center of the width of work machine 100. This arrangement helps equal distribution of water or other hydrating fluid 110a on either side of the sapling 122. Although not shown, a suitable framework may be added to support the cantilevered first branch 152 and the second branch 154. The framework also may support all the plumbing hoses which are connected to each nozzle to supply water or hydrating fluid 110a from the hydrating fluid storage tank 110.

The hydrating fluid 110a may comprise of either water, a hydrogel, a fertilizer, or some mixture thereof.

Target volume of water may be defined as the intended target volume of water release per sapling 122 and may be decided based on the type of sapling, type of soil, time to spray, size of the saplings etc. The target volume optionally may be defined by hydrating control unit 102 based on signal 127 from identifying unit 140.

The plurality of nozzles 160 may spray a required quantity of water or hydrating fluid 110a. In an embodiment, nozzles may be electronically controlled through the hydrating control unit 102 with precision. Various parameters may be involved in operating a nozzle such as, but not limited to, maximum flow capability, variable flow control, spray start / open time control and spray stop / close control. In the embodiment shown, sixteen nozzles are used. However, the number of nozzles will be dependent on the target volume of water input for a single sapling 122 and each nozzle must deliver a fraction of the target water volume. The electrical wiring for each nozzle is connected to the hydrating control unit 102 and may be routed through the framework.

When the identifying unit 140 generates a signal, the hydrating control unit 102 defines a zone 146 (FIG. 1) around the sapling 122 based on location of the sapling 122. The size and shape of the zone could be predetermined by a user, or the hydrating control unit 102 may define the zone 146 based on the type and dimensions of the sapling. It is also contemplated that the zone can be defined in different shapes and dimensions. In an embodiment, the zone 146 may be defined by volumetric space surrounding the sapling 122 (preferably sapling will be the center of the zone) having defined by a diameter and height within which the water has to be sprayed for efficient water absorption by the sapling 122.

To spray the target volume of water for a sapling 122, the plurality of nozzles 160 have to be operated in sequence 300 such that a fraction of target water volume is sprayed by each nozzle and the spray output of each nozzle has to fall within the defined zone 146 for each sapling 122.

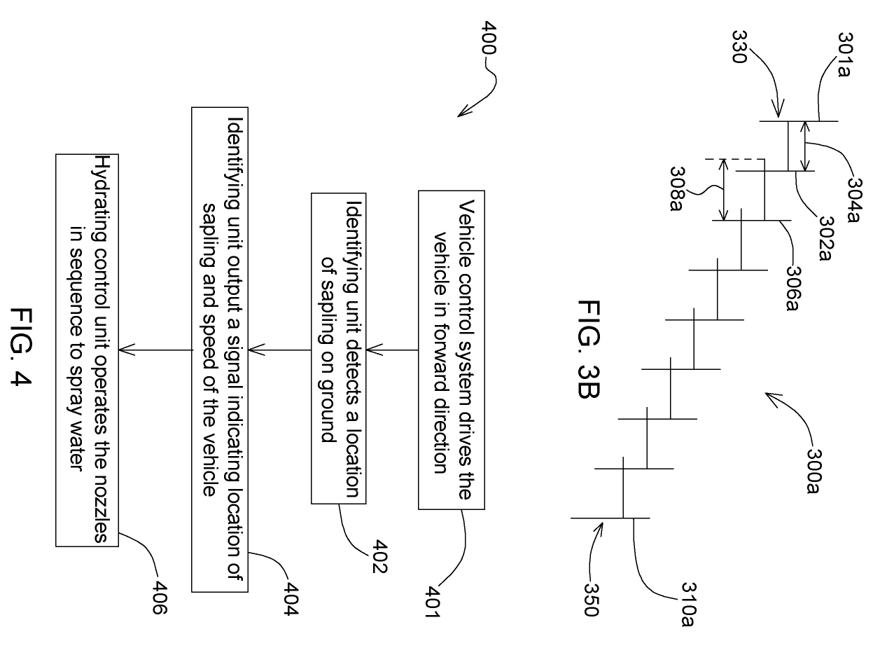

The hydrating control unit 102 decides the sequence 300 (FIG. 3A) parameters based on the signal from the sensor, number of nozzles and position of the nozzles on the boom 150. The start point 330 of the sequence 300 is the time at which the first nozzle is opened and is decided by the hydrating control unit 102 based on ground speed of the work machine 100 and the zone 146 around the sapling 122 on ground 120 such that when the first nozzle FA1 is opened, the water sprayed falls within the zone 146 around the sapling 122. Similarly, the end point 350 of sequence 300 is defined by the time the last nozzle FA8 in the first array 156 on boom 150 is closed, and the water sprayed by last nozzle should fall within the zone 146.

FIGS. 3A and 3B illustrate two embodiments of sequencing strategies to operate the plurality of nozzles 160. The sequence 300 is illustrated by using eight nozzles and plotting timing of the opening and closing of each nozzle in an array. In the embodiment shown in FIG. 3A, all nozzles are kept open for equal duration of time and each consecutive nozzle is opened after the preceding nozzle is closed. For a given array the first nozzle is opened 301 and closed 302 and the duration of nozzle opening time is represented by 304. As the first nozzle is closed at 302 and at the same time the second nozzle is opened the duration of opening is represented by 308 and closing is at 306. This continues till the eighth nozzle closing at 310. This also represents the end of sequence 350.

In the embodiment shown in FIG. 3B, every nozzle is opened for a small duration before the preceding nozzle is closed. For a given array, the sequence starts 300 by opening the first nozzle 301a and closing at 302a and for duration represented by 304a. The second nozzle opens a little earlier than 302a and ends at 306a and for duration represented by 308a. It is evident that the duration of opening for the second nozzle 308a is greater than duration of opening for the first nozzle 304a. This allows a smooth water flow to the sapling 122 compared to sequence 300.

If multiple arrays of nozzles are available as shown in FIG. 2, the hydrating control unit 102 may follow the same sequence for all arrays in sync. It is also possible that hydrating control unit 102 may assign different sequence strategies (eg, 300, 300a) for different arrays. However, it is possible that many other sequence strategies are possible to implement. It is also possible to store a plurality of strategies and the operator may select via a display in the cab 113 or hydrating control unit 102 auto selects appropriate strategy or the hydrating control unit 102 may create an appropriate sequence strategy based on variables.

Considering FIGS. 1 to 3B, the working of the work machine 100 is described further below. As the work machine 100 moves in forward direction 130, The identifying unit 140 is in communication with the sensor 126 or the data storage to identify the location of a sapling 122. Upon identifying the location of a sapling 122, the identifying unit 140 generates a signal. The signal may comprise the location of the sapling 122 and ground speed of the work machine 100. The hydrating control 102, based on location of the sapling 122, defines a zone 146 around the sapling 122 as discussed earlier. As the work machine 100 is moving forward, and the zone 146 is defined, the hydrating control unit 102 decides the appropriate time at which the sequence of nozzle operation start 330 and the first nozzle FA1 from the first array 156 and first nozzle SA1 of second array 158 should start spraying. Since the first nozzles on both branches are on same plane as discussed earlier, water sprayed by both nozzles with fall into the zone 146 surrounding the sapling 122 at the same time. Since the work machine 100 is moving forward 130, the first nozzles FA1 & SA1 are closed and second nozzles from each array FA2 & SA2 are opened according to selected sequence and the water sprayed from second nozzles fall in plane for second nozzles and within the zone 146. This is continued for all nozzles in the series till the end of the sequence. The entire operation is now repeated for each identified location of sapling 122 on the ground 120.

FIG. 4 is flowchart describing the sequence of events or method 400 in the automatic irrigation system. In a first step 401, the work machine 100 is driven in a silviculture field across the row of entities or saplings 122. In an embodiment, the hydrating control unit 102 may drive the work machine 100 according to the predetermined path. As the work machine 100 moves in a forward direction 130, in second step 402 the identifying unit 140 identifies the location of the sapling 122 based on input from a sensor 126 or from a pre-recorded file. At step three 404, the identifying unit 140 generates a signal. The signal may include the position of the entity or sapling 122 on the ground 120 with respect to the chassis 106 and speed of the work machine 100. As a fourth step 406, the hydrating control unit 102 takes the signal including the sapling position and vehicle speed as input and operate the plurality of nozzles 160 located on fluid delivery member in a sequence 300 such that the water sprayed from nozzles fall close to the sapling 122. Once the target quantity of water is delivered to the sapling 122, Steps one to four are continued in loop as the work machine 100 is traversing in the field or on the ground 120.

The present disclosure has several technical advancements, including but not limited to the realization of vision based detection of saplings 122, operating a plurality of nozzles 160 and achieving continuous spray of water to saplings 122, and high speed irrigation of saplings 122 without having any moving parts by an irrigation vehicle.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A work machine for irrigation of an entity, the work machine comprising:
a chassis comprising a rear end, a proximal end, and a length defined between the rear end and the proximal end; and
a hydrating module coupled to the chassis, the hydrating module comprising a hydrating fluid storage tank, a plurality of nozzles fluidly coupled to the hydrating fluid storage tank, and a hydrating control unit;
wherein the plurality of nozzles is arranged parallel to the length and the hydrating control unit operates the plurality of nozzles to dispense a hydrating fluid.

2. The work machine as claimed in claim 1, wherein the work machine further comprises an identifying unit to determine a location of the entity and generate a signal based on the location of the entity and a ground speed of the work machine and the hydrating control unit operates the plurality of nozzles in a sequence based on the signal such that the hydrating fluid is sprayed towards the location of the entity.

3. The work machine as claimed in claim 2, wherein the location of the entity is defined by a distance between the entity and the work machine.

4. The work machine as claimed in claim 2, wherein the entity comprises a sapling or a plant.

5. The work machine as claimed in claim 2, wherein the sequence includes operating each nozzle individually and initiating the sequence by operating the nozzle adjacent to the rear end.

6. The work machine as claimed in claim 1, wherein operating each nozzle is defined by an opening time and a closing time after the signal is generated by the identifying unit.

7. The work machine as claimed in claim 1, wherein the plurality of nozzles is arranged in series.

8. The work machine as claimed in claim 7, wherein the plurality of nozzles is grouped into a first array and a second array.

9. The work machine as claimed in claim 8, wherein the first array and second array are positioned parallel to each other.

10. The work machine as claimed in claim 2, wherein a zone is defined by a volumetric space around the entity and the nozzles are operated such that the hydrating fluid is sprayed in the zone.

11. A system for irrigation of an entity, the system comprising:
a work machine having a chassis, a rear end, a proximal end and a length between the rear end and the proximal end; and
a hydrating module coupled to the chassis, the hydrating module comprising a hydrating fluid storage tank, a plurality of nozzles fluidly coupled to the hydrating fluid storage tank, and a hydrating control unit;
wherein the plurality of nozzles is arranged parallel to the length and the hydrating control unit operates the plurality of nozzles to dispense a hydrating fluid.

12. The system for irrigation as claimed in claim 11, wherein the work machine further comprises an identifying unit to determine a location of the entity and generate a signal based on the location of the entity and a ground speed of the work machine and the hydrating control unit operates the plurality of nozzles in a sequence based on the signal such that the hydrating fluid is sprayed towards the location of the entity.

13. The system for irrigation as claimed in claim 12, wherein the location of entity is defined by a distance between the entity and the work machine.

14. The system for irrigation as claimed in claim 12, wherein the entity comprises a sapling or a plant.

15. The system for irrigation as claimed in claim 12, wherein the sequence includes operating each nozzle individually and initiating the sequence by operating the nozzle adjacent to the rear end.

16. The system for irrigation as claimed in claim 11, wherein operating each nozzle is defined by an opening time and a closing time after the signal is generated by the identifying unit.

17. The system for irrigation as claimed in claim 11, wherein the plurality of nozzles is arranged in series.

18. The system for irrigation as claimed in claim 17, wherein the plurality of nozzles is grouped into a first array and a second array.

19. The system for irrigation as claimed in claim 18, wherein the first array and second array are positioned parallel to each other.

20. The system for irrigation as claimed in claim 12, wherein a zone is defined by a volumetric space around the entity and the nozzles are operated such that the hydrating fluid is sprayed in the zone.
